(19) United States
(12) Patent Application Publication
(10) Pub. No.: US 2025/0078489 A1
(43) Pub. Date: Mar. 6, 2025

(54) FULLY ATTENTIONAL NETWORKS WITH SELF-EMERGING TOKEN LABELING

(71) Applicant: NVIDIA CORPORATION, Santa Clara, CA (US)

(72) Inventors: Bingyin ZHAO, Central, SC (US); Jose Manuel ALVAREZ LOPEZ, Mountain View, CA (US); Anima ANANDKUMAR, Pasadena, CA (US); Shi Yi LAN, San Jose, CA (US); Zhiding YU, Santa Clara, CA (US)

(21) Appl. No.: 18/542,423

(22) Filed: Dec. 15, 2023

Related U.S. Application Data
(60) Provisional application No. 63/579,891, filed on Aug. 31, 2023.

(51) Int. Cl. G06V 10/82; G06V 10/77

(52) U.S. Cl. CPC G06V 10/82; G06V 10/7715

(57) ABSTRACT

One embodiment of the present invention sets forth a technique for training an image classifier. The technique includes training a first vision transformer model to generate patch labels for corresponding images patches of images, converting the patch labels to token labels, and training a second vision transformer model to classify images based on the token labels.

### CROSS-REFERENCE TO RELATED APPLICATIONS

This application claims benefit of the United States Provisional Patent Application titled “FULLY ATTENTIONAL NETWORKS WITH SELF-EMERGING TOKEN LABELING,” filed Aug. 31, 2023, and having Ser. No. 63/579,891. The subject matter of this related application is hereby incorporated herein by reference.

### BACKGROUND

### Field of the Various Embodiments

The various embodiments relate generally to computer science and image classification and, more specifically, to fully attentional networks with self-emerging token labeling.

### DESCRIPTION OF THE RELATED ART

Vision Transformers (ViTs) are a family of deep neural networks built upon transformers. A VIT includes an encoder and a decoder. The encoder is trained to recognize relevant characteristics of an input image and the decoder is trained to convert the relevant characteristics of the image into useful information, such as a classification for the image that indicates what the image is a picture of. A ViT divides an image into a sequence of non-overlapping fixed-size image patches corresponding to an area within the image. The VIT then converts these image patches into a set of tokens identifying the content (i.e., the classification) of each of the image patches. The tokens are then associated with the position information indicating where the corresponding image patch is located within the image. The resulting patch tokens and an extra image classification token identifying the content of the image as a whole are then fed into the encoders of the transformer within the VIT. The encoders consist of multi-head self-attention and Feed Forward Network (FFN) blocks that determine the contextual relevance of the patch tokens with respect to each other. The decoder in a ViT is connected to different layers of the encoder so as to provide different emphasis on local and global information, which improves the performance of the VIT. The decoder then generates an output indicating the likelihood that the image includes content of one or more classes (e.g., a dog, a cat, a fish, etc.). A Fully Attentional Network (FAN) is a type of ViT that includes the self-attention blocks of a ViT but further includes a channel attention block. The channel attention block gives importance to specific levels of the FAN and combines information from the different layers in a more holistic manner leading to a better understanding of objects with different sizes and shapes in the input image.

ViTs have been successful in visual recognition tasks due to their self-attention mechanisms, which have been trained using techniques such as data augmentation and knowledge distillation. One strategy for improving ViTs is to augment the training data to include multi-label annotations instead of a single classification annotation for the entire image. Each of the annotations corresponds to a token label for a corresponding image patch and identifies the class corresponding to the content in the image patch. The dense nature of these image tokens provides more fine-grained information to ViTs, such as the locations of objects of different classes in an image. One strategy for generating the token labels utilizes the image classification properties of Convolutional Neural Networks (CNNs). One drawback of using CNNs for generating the token labels is that the CNNs have poor robustness when generating token labels for out of distribution data, such as corrupted or noisy images, because the CNNs primarily emphasize capturing localized relationships within their computations rather than considering the noisy image as a whole.

As the forgoing illustrates, what is needed in the art are more accurate and robust techniques for generating token labels used to improve the training and robustness of ViT models.

### SUMMARY

According to some embodiments, a computer-implemented method for training an image classifier includes training a first vision transformer model to generate patch labels for corresponding images patches of images, converting the patch labels to token labels, and training a second vision transformer model to classify images based on the token labels.

Further embodiments provide, among other things, non-transitory computer-readable storage media storing instructions and system configured to implement the method set forth above as well as other methods to train vision transformer models to perform other image processing tasks. Additional embodiments provide, among other things, methods, non-transitory computer-readable media storing instructions and systems for performing image processing tasks using vision transformers trained according to the methods set forth above.

One technical advantage of the disclosed techniques relative to the prior art is that, with the disclosed techniques, more accurate token labels are generated for the image patches within training images. The more accurate token labels provide improved training data for image processing tasks, such as image classification. The improved training data results in a trained image processing models that more accurately identifies the content of images. Another technical advantage of the disclosed techniques is that image processing models trained using the disclosed techniques are better at classifying out of distribution data, such as corrupted or noisy images, than corresponding image processing models trained using other techniques. A further technical advantage is that some smaller image processing models trained using the disclosed techniques can be as effective as some larger image processing models trained using prior approaches, allowing image processing tasks to be performed as effectively using fewer memory and computational resources. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be found by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of the present disclosure;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 is a block diagram of a computing device according to one or more aspects of the present disclosure;

FIG. 5 is an illustration of the training engine in FIG. 4 during the training of the teacher model according to various embodiments;

FIG. 6 is an illustration of the training engine in FIG. 4 during the training of the student model according to various embodiments;

FIG. 7 illustrates the impact of the Gumbel SoftMax in FIG. 6 on an input image according to one or more aspects of the present disclosure;

FIG. 8 is an illustration of the execution engine in FIG. 4 according to various embodiments;

FIG. 9 is a flow diagram of method steps for using token labels for image classification, according to various embodiments;

FIG. 10 is a flow diagram of method steps for training a teacher model to produce token labels, according to various embodiments;

FIG. 11 is a flow diagram of method steps for training a student model with token labels, according to various embodiments; and

FIG. 12 is a flow diagram of method steps for classifying images using the trained student model, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. And although the embodiments below are described primarily from the perspective of VITs used to classify images, the disclosed techniques are equally applicable to VITs used to perform other image processing tasks.

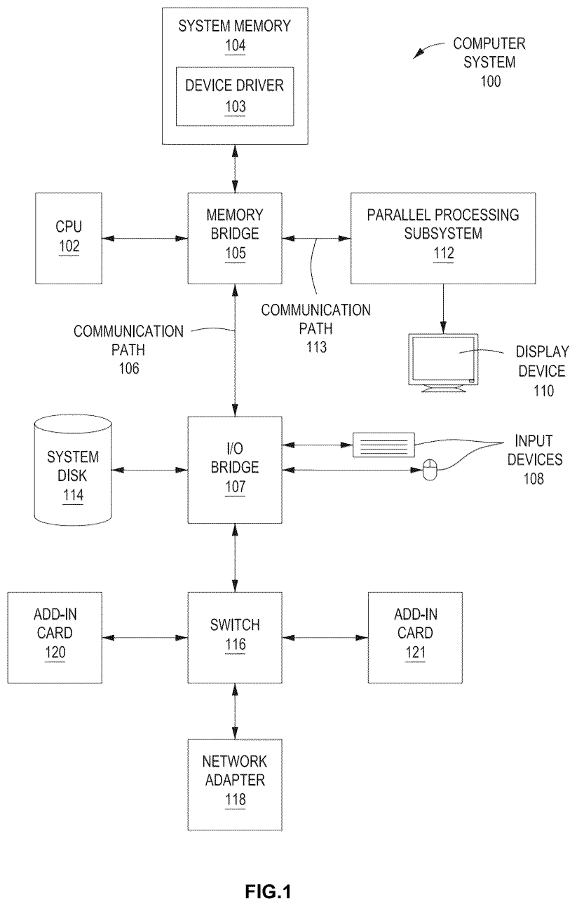

FIG. 1 is a block diagram of a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116. As persons skilled in the art will appreciate, computer system 100 can be any type of technically feasible computer system, including, without limitation, a server machine, a server platform, a desktop machine, laptop machine, or a hand-held/mobile device.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that can be configured to store content and applications and data for use by CPU 102 and parallel processing subsystem 112. As a general matter, system disk 114 provides non-volatile storage for applications and data and can include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, can be connected to I/O bridge 107 as well.

In various embodiments, memory bridge 105 can be a Northbridge chip, and I/O bridge 107 can be a Southbridge chip. In addition, communication paths 106 and 113, as well as other communication paths within computer system 100, can be implemented using any technically suitable protocols, including, without limitation, AGP (Accelerated Graphics Port), HyperTransport, or any other bus or point-to-point communication protocol known in the art.

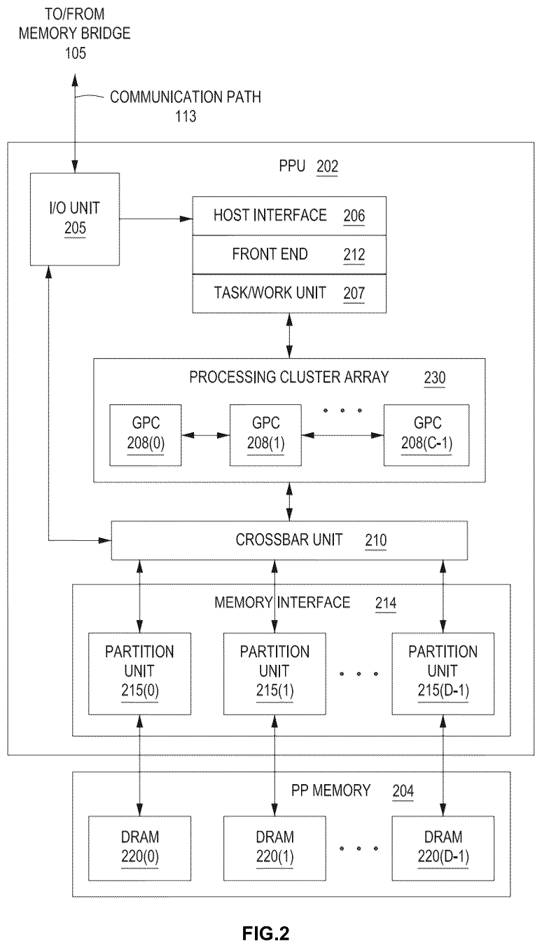

In some embodiments, parallel processing subsystem 112 comprises a graphics subsystem that delivers pixels to a display device 110 that can be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry can be incorporated across one or more parallel processing units (PPUs) included within parallel processing subsystem 112. In other embodiments, the parallel processing subsystem 112 incorporates circuitry optimized for general purpose and/or compute processing. Again, such circuitry can be incorporated across one or more PPUs included within parallel processing subsystem 112 that are configured to perform such general purpose and/or compute operations. In yet other embodiments, the one or more PPUs included within parallel processing subsystem 112 can be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 can be integrated with one or more other the other elements of FIG. 1 to form a single system. For example, parallel processing subsystem 112 can be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, can be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 can be connected to I/O bridge 107 or directly to CPU 102, rather than to memory bridge 105. In still other embodiments, I/O bridge 107 and memory bridge 105 can be integrated into a single chip instead of existing as one or more discrete devices. Lastly, in certain embodiments, one or more components shown in FIG. 1 can not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to various embodiments of the present invention. Although FIG. 2 depicts one PPU 202, as indicated above, parallel processing subsystem 112 can include any number of PPUs 202. As shown, PPU 202 is coupled to a local parallel processing (PP) memory 204. PPU 202 and PP memory 204 can be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that can be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 can be used to store and update pixel data and deliver final pixel data or display frames to display device 110 for display. In some embodiments, PPU 202 also can be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that can be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities can be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks can be directed to a host interface 206, while commands related to memory operations (e.g., reading from or writing to PP memory 204) can be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 can be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 can be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end unit 212 from the host interface 206. Processing tasks that can be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority can be specified for each TMD that is used to schedule the execution of the processing task. Processing tasks also can be received from the processing cluster array 230. Optionally, the TMD can include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C D 1. Each GPC 208 is capable of executing a large number (e.g., hundreds or thousands) of threads concurrently, where each thread is an instance of a program. In various applications, different GPCs 208 can be allocated for processing different types of programs or for performing different types of computations. The allocation of GPCs 208 can vary depending on the workload arising for each type of program or computation.

Memory interface 214 includes a set of D of partition units 215, where D Q 1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 can be different than the number of DRAMs 220. Persons of ordinary skill in the art will appreciate that a DRAM 220 can be replaced with any other technically suitable storage device. In operation, various render targets, such as texture maps and frame buffers, can be stored across DRAMs 220, allowing partition units 215 to write portions of each render target in parallel to efficiently use the available bandwidth of PP memory 204.

A given GPCs 208 can process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 can use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data can then be accessed by other system components, including CPU 102, another PPU 202 within parallel processing subsystem 112, or another parallel processing subsystem 112 within computer system 100.

As noted above, any number of PPUs 202 can be included in a parallel processing subsystem 112. For example, multiple PPUs 202 can be provided on a single add-in card, or multiple add-in cards can be connected to communication path 113, or one or more of PPUs 202 can be integrated into a bridge chip. PPUs 202 in a multi-PPU system can be identical to or different from one another. For example, different PPUs 202 might have different numbers of processing cores and/or different amounts of PP memory 204. In implementations where multiple PPUs 202 are present, those PPUs can be operated in parallel to process data at a higher throughput than is possible with a single PPU 202. Systems incorporating one or more PPUs 202 can be implemented in a variety of configurations and form factors, including, without limitation, desktops, laptops, handheld personal computers or other handheld devices, servers, workstations, game consoles, embedded systems, and the like.

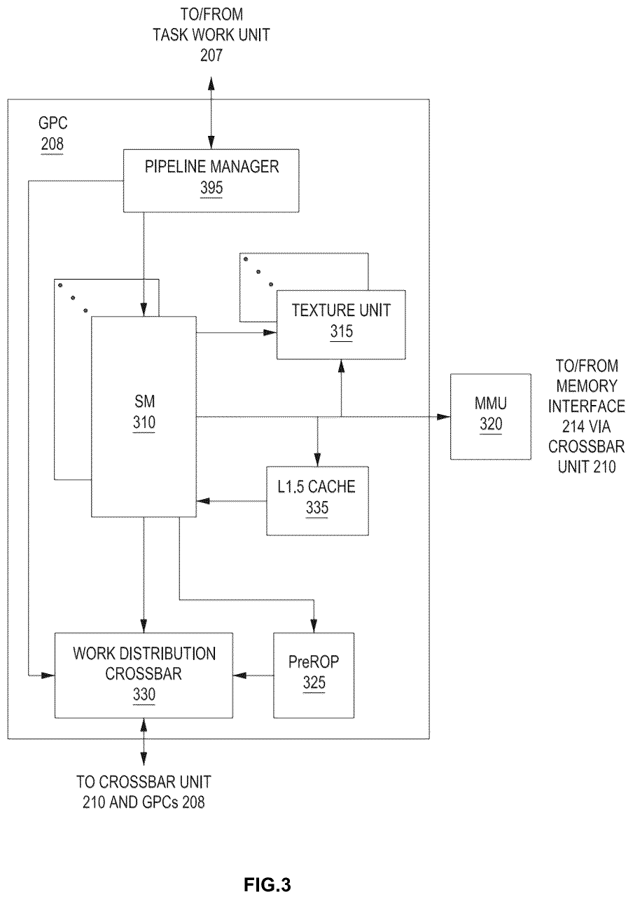

FIG. 3 is a block diagram of a GPC 208 included in PPU 202 of FIG. 2, according to various embodiments of the present invention. In operation, GPC 208 can be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 can also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units can be pipelined, which enables a new instruction to be issued for execution before a previous instruction has completed execution. Any combination of functional execution units within a given SM 310 can be provided. In various embodiments, the functional execution units can be configured to support a variety of different operations including integer and floating point arithmetic (e.g., addition and multiplication), comparison operations, Boolean operations (AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group can include fewer threads than the number of execution units within the SM 310, in which case some of the execution can be idle during cycles when that thread group is being processed. A thread group can also include more threads than the number of execution units within the SM 310, in which case processing can occur over consecutive clock cycles. Since each SM 310 can support up to G thread groups concurrently, it follows that up to G*M thread groups can be executing in GPC 208 at any given time.

Additionally, a plurality of related thread groups can be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches can be used to transfer data between threads. Finally, SMs 310 also have access to off-chip “global” memory, which can include PP memory 204 and/or system memory 104. It is to be understood that any memory external to PPU 202 can be used as global memory. Additionally, as shown in FIG. 3, a level one-point-five (L1.5) cache 335 can be included within GPC 208 and configured to receive and hold data requested from memory via memory interface 214 by SM 310. Such data can include, without limitation, instructions, uniform data, and constant data. In embodiments having multiple SMs 310 within GPC 208, the SMs 310 can beneficially share common instructions and data cached in L1.5 cache 335.

Each GPC 208 can have an associated memory management unit (MMU) 320 that is configured to map virtual addresses into physical addresses. In various embodiments, MMU 320 can reside either within GPC 208 or within the memory interface 214. The MMU 320 includes a set of page table entries (PTEs) used to map a virtual address to a physical address of a tile or memory page and optionally a cache line index. The MMU 320 can include address translation lookaside buffers (TLB) or caches that can reside within SMs 310, within one or more L1 caches, or within GPC 208.

In graphics and compute applications, GPC 208 can be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, can be included within GPC 208. Further, as described above in conjunction with FIG. 2, PPU 202 can include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the present invention.

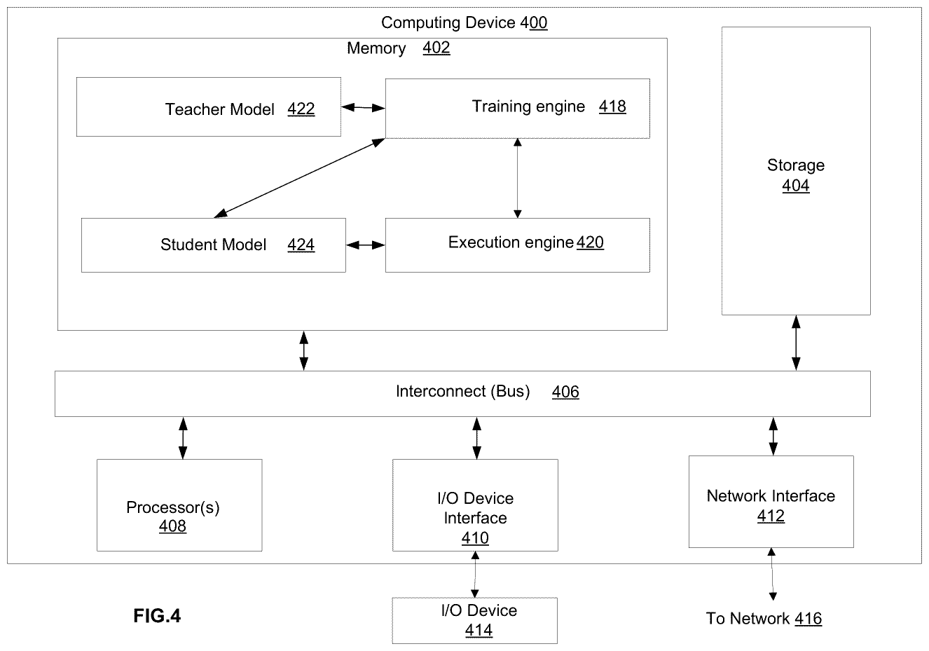

FIG. 4 is a block diagram of a computing device 400 according to one or more aspects of the present disclosure. As shown, computing device 400 includes, without limitation, a memory 402, a storage 404, an interconnect (bus) 406, one or more processor(s) 408, an input/output (I/O) device interface 410, and a network interface 412. Memory 402 includes, without limitation, training engine 418, execution engine 420, teacher model 422, and student model 424. As further shown, computing device 400 is coupled, without limitation, to I/O devices 414 and a network 416.

Computing device 400 could be a desktop computer, a laptop computer, a smart phone, a personal digital assistant (PDA), tablet computer, a remote server, or any other type of computing device configured to receive input, process data, and optionally display images, and is suitable for practicing one or more embodiments. In some embodiments, computing device 400 corresponds to computer system 100 in FIG. 1. Computing device 400 described herein is illustrative and any other technically feasible configurations fall within the scope of the present disclosure.

Processor(s) 408 includes any suitable processor implemented as a central processing unit (CPU), a graphics processing unit (GPU), an application-specific integrated circuit (ASIC), a field programmable gate array (FPGA), an artificial intelligence (AI) accelerator, a multi-core processor, any other type of processor, or a combination of two or more processors of a same or different types. For example, processor(s) 408 could include a CPU and a GPU configured to operate in conjunction with each other. In general, processor(s) 408 can be any technically feasible hardware unit capable of processing data and/or executing software applications. Further, in the context of this disclosure, the computing elements shown in computing device 400 can correspond to a physical computing system (e.g., a system in a data center) or can be a virtual computing instance executing within a computing cloud.

I/O device interface 410 enables communication of I/O devices 414 with processor(s) 408. I/O device interface 410 generally includes the logic for interpreting addresses corresponding to I/O devices 414 that are generated by processor(s) 408. I/O device interface 410 can also be configured to implement handshaking between processor(s) 408 and I/O devices 414, and/or generate interrupts associated with I/O devices 414. I/O device interface 410 can be implemented as any technically feasible interface circuit or system.

In some embodiments, I/O devices 414 include devices capable of providing input, such as a keyboard, a mouse, a touch-sensitive screen, and so forth, as well as devices capable of providing output, such as a display device. Additionally, I/O devices 414 can include devices capable of both receiving input and providing output, such as a touchscreen, a universal serial bus (USB) port, and so forth. I/O devices 414 can be configured to receive various types of input from an end-user (e.g., a designer) of computing device 400, and to also provide various types of output to the end-user of computing device 400, such as displayed digital images or digital videos or text.

Network interface 412 serves as the interface between the computer and the network 416. Network interface 412 facilitates the transmission and reception of data. Network interface 412 includes, without limitation, hardware, software, or a combination of hardware and software. In some embodiments, network interface 412 supports one or more communication protocols, such as Ethernet, Wi-Fi, Bluetooth, among others.

In some embodiments network 416 includes any technically feasible type of communications network that allows data to be exchanged between computing device 400 via network interface 412 and external entities or devices, such as a web server or another networked computing device. For example, network 416 can include a wide area network (WAN), a local area network (LAN), a wireless (WiFi) network, and/or the Internet, among others.

Memory 402 includes a random access memory (RAM) module, a flash memory unit, or any other type of memory unit or combination thereof. Processor(s) 408, I/O device interface 410, and network interface 412 are configured to read data from and write data to memory 402. Memory 402 includes various software programs that can be executed by processor(s) 408 and application data associated with the software programs, such as training engine 418, execution engine 420, teacher model 422 and student model 424. Training engine 418 trains the teacher model 422. Training engine 418 then uses the trained teacher model to train the student model 424. Execution engine 420 uses the trained student model to classify images.

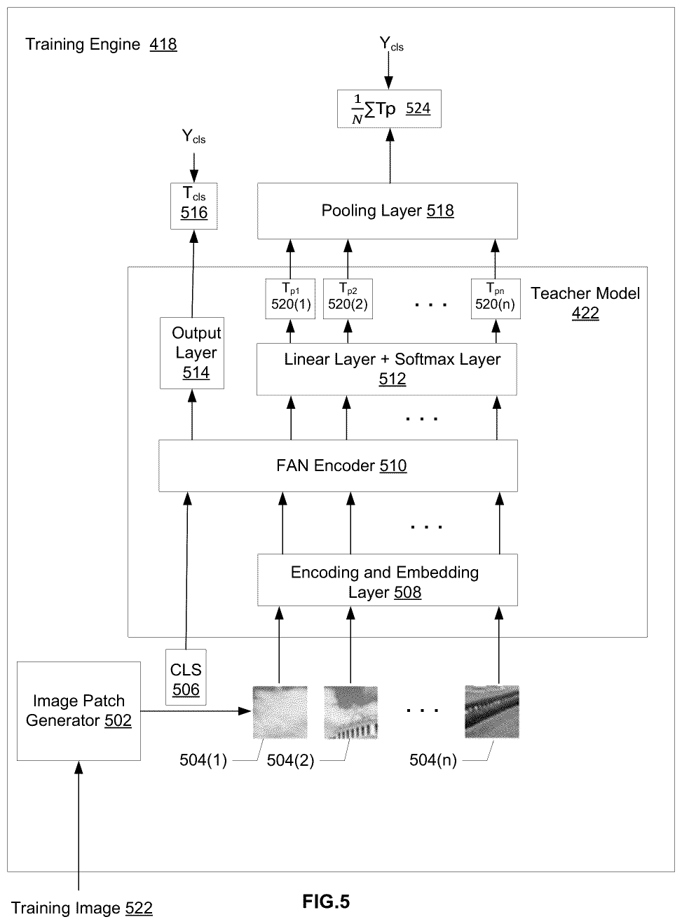

Teacher model 422 is a FAN based model that can generate high-quality token labels. As mentioned above, FAN includes the self-attention blocks of a ViT model but additionally introduces a channel attention block that aggregates the cross-channel information in a more holistic manner, leading to improved representation. The teacher model 422 is described in further detail below with respect to FIG. 5.

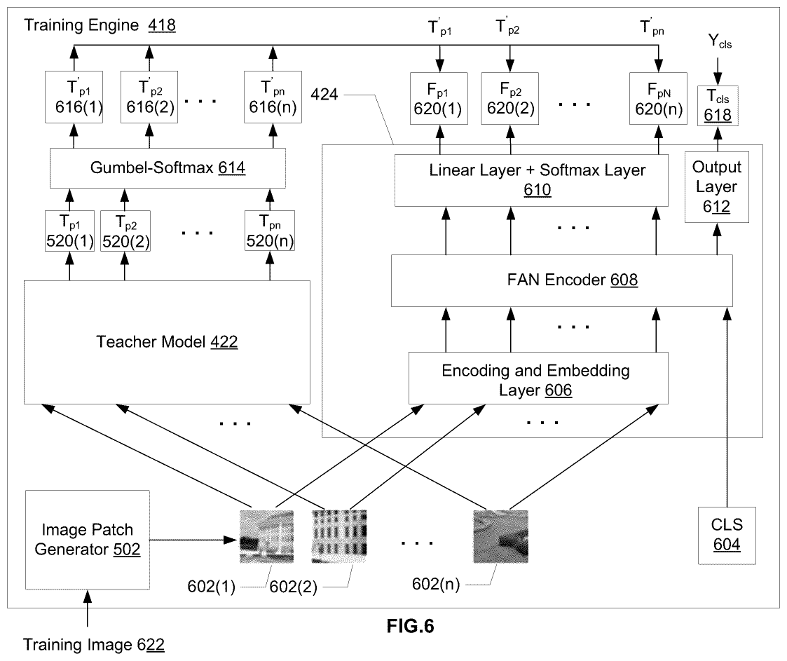

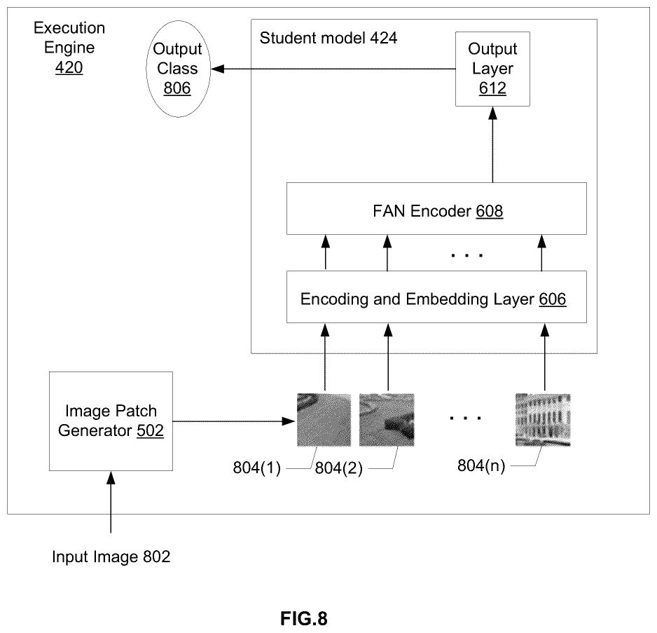

Student model 424 is also a FAN-based model. During training, teacher model 422 generates patch labels that are used to provide token labels for image patches that assist the student model 424 in learning how to classify images. As a result, student model 424 classifies images more accurately than a FAN not provided with token labels for the image patches. In addition, student model 424 can be smaller than other FAN-based models trained without the benefit of the token labels generated by trained teacher model 422. This allows student model 424 to classify images as effectively as other approaches while using fewer memory and/or computational resources. And although student model 424 is described below as an image classifier, student models trained using token labels for image patches generated from patch labels generated by teacher model 422 can also be used for other image processing tasks, such as image classification, image segmentation, image detection, and/or the like. The student model 424 is described in further detail below with respect to FIG. 6 and FIG. 8.

During training of the teacher model 422, training engine 418 updates the parameters of the teacher model 422 so that the teacher model 422 learns to predict patch labels and confidence score for each image patch of an image presented to the teacher model 422. The predicted patch labels are the classification of the corresponding image patches. During training, the loss function used by the training engine 418 evaluates the accuracy of the whole image classification made by the teacher model 422 as well as the accuracy of the patch labels. After the teacher model 422 is trained, training engine 418 trains the student model 424 based on the patch labels generated by the teacher model 422. Training engine 418 emphasizes the patch labels predicted by the teacher model 422 based on the confidence scores of the patch labels to generated token labels that are used as the ground truth for patch labels predicted by the student model 424. During training of the student model 424, training engine 418 updates the parameters of the student model 424 so that the student model 424 learns to predict patch labels for each image patch of an image presented to the student model 424 that match the token labels provided by the trained teacher model 422.

After the student model 424 is trained, the execution engine 420, uses the trained student model 424 to classify input images. The execution engine 420 divides an input image into and provides the image patches to the trained student model 424. The trained student model 424 then predicts a classification for the input image.

Storage 404 includes non-volatile storage for applications and data, and can include fixed or removable disk drives, flash memory devices, and CD-ROM, DVD-ROM, Blu-Ray, HD-DVD, or other magnetic, optical, or solid state storage devices. Training engine 418, execution engine 420, teacher can be stored in storage 404 and loaded into memory 402 when executed. Training engine 418 and execution engine 420 can be stored in storage 404 and loaded into memory 402 when executed.

FIG. 5 is an illustration of training engine 418 during the training of the teacher model 422 according to various embodiments. As shown in FIG. 5, training engine 418 includes, without limitation, an image patch generator 502, a class input CLS 506, teacher model 422, and a pooling layer 518. Teacher model 422 includes, without limitation, an encoding and embedding layer 508, a FAN encoder 510, a linear and SoftMax layer 512 and an output layer 514. During each iteration in the training of teacher model 422, training engine receives a training image 522 and a ground truth classification Y_{cls} for training image 522.

Image patch generator 502 splits the training image into N image patches 504(1)-504(N) to be presented to the teacher model 422. For example, image patch generator 502 generates 16*16 non overlapping image patches 504.

Class input CLS 506 is a special classification token randomly generated by training engine 418 with each training image to represent whole image classification. Because each image patch 504 has an embedding given to the FAN encoder, an embedding that represents the whole image improves training. For this purpose, the CLS 506 is presented to FAN encoder 510.

The image patches 504(1)-504(N) generated by image patch generator 502 are presented to the encoding and embedding layer 508. The encoding and embedding layer 508, creates a token by generating corresponding embeddings of each of the image patches 504. The embedding converts an image patch 504(1)-504(N) into high-dimensional vectors, capturing semantic relationships and contextual information for subsequent attention-based processing by teacher model 422. After the embedding token is produced, a positional encoding representing the position (e.g., x-coordinate, y-coordinate, pixel locations, etc.) of the corresponding image patch 504 is added to the embedding token to generate a position-encoded token representing the image patch 504.

FAN encoder 510 is a type of vision transformer model with an excellent capability for object localization without explicit supervision. Similar to transformers, FAN encoder 510 includes self-attention blocks but also includes a channel attention block that aggregates the cross-channel information in a more holistic manner, leading to an improved representation of the semantic content of images. FAN encoder 510 includes transformer blocks that use attention units to process position-encoded tokens generated by the encoding and embedding layer 508. For example, FAN encoder 510 could include a multi-head attention unit, a multilayer perceptron, one or more normalization layers, and/or one or more residual connections from the input of a given component (e.g, the multi-head attention unit, the multilayer perceptron, the one or more normalization layers, etc.) to the output of the same component. Input to FAN encoder 510 receives the position-encoded tokens generated by encoding and embedding layer 508 and class input CLS 506. FAN encoder 510 processes the position-encoded tokens to generate updated tokens. The updated tokens correspond to the semantic content of images for each image patch. The output of FAN encoder 510 is then presented to linear layer and softmax layer 512 and output layer 514.

The updated tokens generated by FAN encoder 510 are presented to a feedforward neural network layer commonly referred to as the linear layer and softmax layer 512. The linear layer and softmax layer 512 analyze the updated tokens generated by FAN encoder 510 to generate patch labels 520(1)-520(N). Patch labels 520 represent the semantic meaning or classification of the content of each patch. Each patch label 520 has a confidence score indicating how confident teacher model 422 is in the corresponding patch label 520. The confidence score is the maximal class probability of each patch label 520. The patch labels 520 are presented to pooling layer 518.

Pooling layer 518 computes the average of patch labels 520 to generate an average patch label 524. Training engine 418 uses the average patch label 524 to calculate a loss function value for teacher model 422. In order to calculate the loss, image label Y_{cls} is used in the training engine 418 as the ground truth.

The updated tokens generated by FAN encoder 510 are also presented to output layer 514. Output layer 514 includes one or more linear layers, such as a multilayer perceptron. Output layer 514 processes the updated tokens generated to FAN encoder 510 to generate a class token T_{cls} 516. Class token T_{cls} corresponds to the classification assigned by teacher model 422 to training image 522.

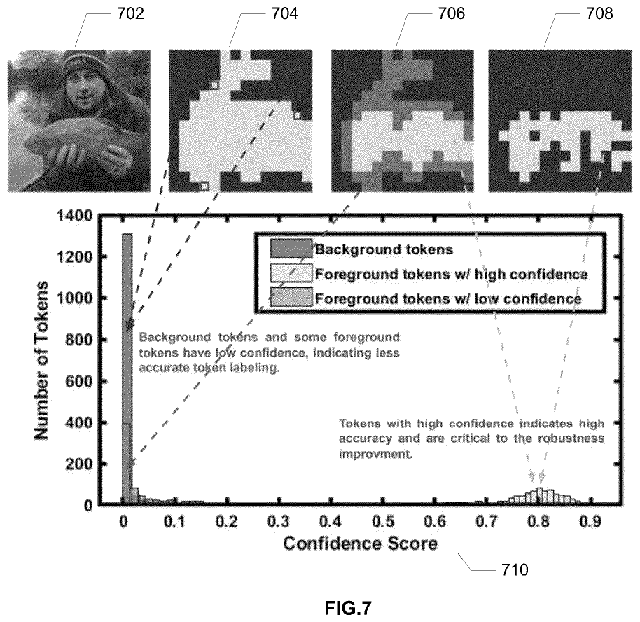

Training engine 418 uses the class token T_{cls} 516, the average patch label 524 output by pooling layer 518, and the image label Y_{cls} for the training image 522 to compute a loss function. Training engine 418 uses the image label Y_{cls} and class token T_{cls} 516 to compute the whole image loss. In addition, that average patch label 524 and image label Y_{cls} are used to compute patch label losses. Training engine 418 then combines both losses into an overall loss according to Equation 1.

$$L = ℋ ( {T}_{cls} , {Y}_{cls} ) + α * ℋ ( \frac{1}{N} {\sum }_{i = 1}^{N} {T}_{{p}_{i}} , {Y}_{cls} ) \qquad Equation 1$$

Where α weights the relative importance of patch label loss and [symbol] (.) is the softmax cross entropy loss function or any other suitable metric for the loss function. Examples of the patch labels 520 generated by teacher model 422 are shown in FIG. 7. After computing the total loss, training engine 418 uses a training technique (e.g., gradient descent, backpropagation, and/or the like) to update the parameters of teacher model 422 based on loss computed for the training image. Training engine 418 repeats the process of presenting training images, calculating the overall loss, and updating the teacher model 422 parameters until a predefined stopping criteria is met. An example of the stopping criteria is that an aggregate of the loss functions for a set of training or test images has converged for a set number of iterations.

FIG. 6 is an illustration of training engine 418 during the training of student model 424 according to various embodiments. As shown in FIG. 6, training engine 418 includes, without limitation, image patch generator 502, a class input CLS 604, student model 424, teacher model 422, and a Gumbel-Softmax block 614. Student model 424 includes, without limitation, an encoding and embedding layer 606, a FAN encoder 608, a linear and SoftMax layer 610, and an output layer 612. During each iteration in the training of student model 424, training engine 418 receives a training image 622 and a ground truth classification Y_{cls} for training image 622.

Image patch generator 502 splits the training image 622 into N image patches 602(1)-602(N) to be presented to the student model 424. For example, image patch generator 502 generates 16*16 non overlapping image patches 602.

Class input CLS 604 is a special classification token randomly generated by training engine 418 with each training image to represent whole image classification. Since each image patch 602 has an embedding given to the FAN encoder, an embedding that represents the whole image improves training. For this purpose, the class input CLS 604 is presented to FAN encoder 608.

The image patches 602(1)-602(N) generated by image patch generator 502 are presented to the encoding and embedding layer 606. The image patches 602 are also presented to the teacher model 422. The encoding and embedding layer 606, creates a token by generating corresponding embeddings of each of the image patches 602. The embedding converts an image patch 602(1)-602(N) into high-dimensional vectors, capturing semantic relationships and contextual information for subsequent attention-based processing by student model 424. After the embedding token is produced, a positional encoding representing the position (e.g., x-coordinate, y-coordinate, pixel locations, etc.) of the corresponding image patch 602 is added to the embedding token to generate a position-encoded token representing the image patch 602.

FAN encoder 608 includes transformer blocks that use attention units to process position-encoded tokens generated by the encoding and embedding layer 606. For example, FAN encoder 608 could include a multi-head attention unit, a multilayer perceptron, one or more normalization layers, and/or one or more residual connections from the input of a given component (eg, the multi-head attention unit, the multilayer perceptron, the one or more normalization layers, etc.) to the output of the same component. Input to FAN encoder 608 receives the position-encoded tokens generated by encoding and embedding layer 606 and class input CLS 604. FAN encoder 608 processes the position-encoded tokens to generate updated tokens. The updated tokens correspond to semantic content of images for each image patch. The output of FAN encoder 608 is then presented to linear layer and softmax layer 610 and output layer 612.

The updated tokens generated by FAN encoder 608 are presented to a feedforward neural network layer commonly referred to as the linear layer and softmax layer 610. The linear layer and softmax layer 610 analyze the updated tokens generated by FAN encoder 608 to generate patch labels 620(1)-620(N). Patch labels 620 represent the semantic meaning or classification of the content of each patch. Patch labels 620 are then compared with token labels 616 to compute a loss function.

The updated tokens generated by FAN encoder 608 are also presented to output layer 612. Output layer 612 includes one or more linear layers, such as a multilayer perceptron. Output layer 612 processes the updated tokens generated to FAN encoder 608 to generate a class token T_{cls} 618. Class token T_{cls} 618 corresponds to the classification assigned by student model 424 to training image 622.

As mentioned above, image patches 602(1)-602(N) are also presented to the teacher model 422. The teacher model 422 then generates patch labels 520(1)-520(N) and confidence scores as explained in FIG. 5. In order to generate highly accurate patch labels to train the student model 424, a confidence score of each patch label 520(1)-520(N) is examined to emphasize patch labels that have a high confidence score. The patch labels 520 are emphasized using Gumbel-Softmax block 614 to the confidence scores according to Equation 2.

$${y}_{i} = \frac{{e}^{( log ( {π}_{i} ) + {g}_{i} ) / τ}}{{\sum }_{i = 1}^{k} {e}^{( log ( {π}_{i} ) + {g}_{i} ) / τ}} \qquad Equation 2$$

where y is the k-dimension softmax vector, π are class confidence scores for each patch label 520, g is the Gumbel(0, 1) function drawing samples from the standard Gumbel distribution, and T is the softmax temperature. The softmax temperature controls how closely samples from the Gumbel-Softmax distribution approximate those from the categorical distribution. By applying Equation 2, patch labels 520 with high confidence scores remain unchanged, while patch labels 520 with low confidence scores are more likely to change. The patch labels 520 processed by Gumbel-Softmax block 614 more accurately represent the classification of the image patches 602 in training image 622. Gumbel-SoftMax block 614 generates token labels 616(1)-616(N), which are presented as ground truth values for the patch labels 620(1)-620(N) generated by student model 424. Examples of the patch labels 520 generated by teacher model 422 and token labels 616 generated by Gumbel-SoftMax 614 are shown in FIG. 7.

Training engine 418 uses the class token T_{cls} 618, the patch labels 620, the image label Y_{cls} for the training image 622, and the token labels 616 to compute a loss function. Training engine 418 uses the image label Y_{cls} and class token T_{cls} 618 to compute the whole image loss. In addition, patch labels 620 and token labels 616 are used to compute patch label losses for student model 424. Training engine 418 then combines both losses into an overall loss according to Equation 3.

$$ℒ = ℋ ( {T}_{cls} , {Y}_{cls} ) + β * \frac{1}{N} {\sum }_{i = 1}^{N} ℋ ( {T}_{{p}_{i}} , F ( {I}_{{p}_{i}} ) ) \qquad Equation 3$$

Where β weights the relative importance of patch label loss and [symbol] (.) is e softmax cross entropy loss function or any other suitable metric for the loss function. Tₚ are the token labels 616 and F(Iₚᵢ) are patch labels 620. After computing the total loss, training engine 418 uses a training technique (e.g., gradient descent, backpropagation, and/or the like) to update the parameters of student model 424 based on loss computed for the training image. Training engine 418 repeats the process of presenting training images, calculating the overall loss, and updating the student model 424 parameters until a predefined stopping criteria is met. An example of the stopping criteria is that an aggregate of the loss functions for a set of training or test images has converged for a set number of iterations.

FIG. 7 illustrates the impact of the Gumbel-SoftMax block 614 in FIG. 6 on an input image 702 according to one or more aspects of the present disclosure. As mentioned in description of FIG. 5 and FIG. 6, the teacher model 422 generates patch labels 520(1)-520(N) and corresponding confidence scores for patch labels 520(1)-520(N). Training engine 418 then process patch confidence scores with Gumbel-Softmax block 614 to produce token labels 616(1)-616(N). In FIG. 7, an input image 702 with a target object class “tench fish”.

A patch label map 704 shows the classification of the image patches of input image 702 as either foreground patches (shown in white) and background patches (shown in black). A patch label map 706 shows the confidence level of the patch labels with patch labels having a low confidence score shown in dark grey, patch labels with a high confidence score shown in white, and patch labels for background patches shown in black. A histogram 710 shows the distribution of each of the patch labels in patch label map 706.

A patch label map 708 shows the emphasis placed on the patch labels with a high confidence score by Gumbel-Softmax block 614. As shown in patch label map 708, the foreground patch labels with a low confidence score have been converted to background patch labels. The patch labels as emphasized by the Gumbel-Softmax represent the token labels provided by training engine 418 as token labels 616 for use during the training of student model 424.

FIG. 8 is an illustration of the execution engine 420 according to various embodiments. Execution engine 420 includes, without limitation, image patch generator 502 and trained student model 424. Trained student model 424 includes, encoding and embedding layer 606, FAN encoder 608 and output layer 612. At the run time, execution engine 420 receives an input image 802 to be processed.

Image patch generator 502 splits the input image 802 into N image patches 804(1)-804(N) to be presented to trained student model 424. For example, image patch generator 502 generates 16*16 non overlapping image patches 804.

The image patches 804(1)-804(N) generated by image patch generator 502 are presented to the encoding and embedding layer 606. The encoding and embedding layer 606 creates a token by generating corresponding embeddings of each of the image patches 804. The embedding converts an image patch 804(1)-804(N) into high-dimensional vectors, capturing semantic relationships and contextual information for subsequent attention-based processing by the trained student model 424. After the embedding token is produced, a positional encoding representing the position (e.g., x-coordinate, y-coordinate, pixel locations, etc.) of the corresponding image patch 804 is added to the embedding token to generate a position-encoded token representing the image patch 804.

FAN encoder 608 then receives the position-encoded tokens generated by encoding and embedding layer 606. FAN encoder 608 processes the position-encoded tokens to generate updated tokens. The updated tokens correspond to semantic content of images for each image patch. The output of FAN encoder 608 is then presented to output layer 612.

Output layer 612 includes one or more linear layers, such as a multilayer perceptron. Output layer 612 processes the updated tokens generated to FAN encoder 608 to generate output class 806 which represents the trained student model 424 classification output for the input image 802.

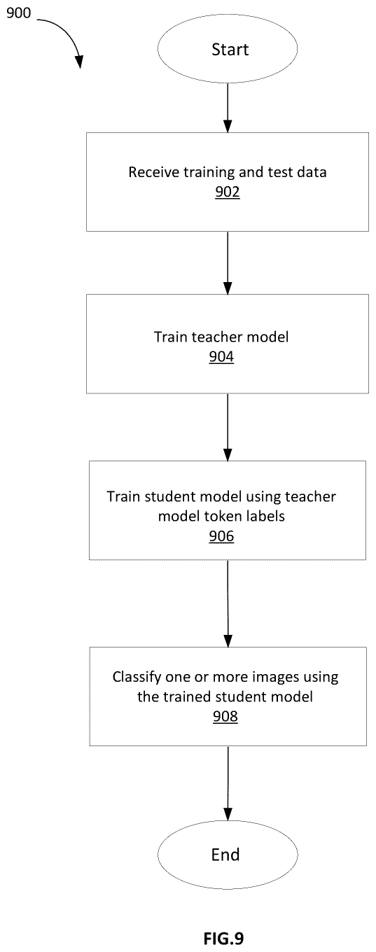

FIG. 9 is a flow diagram of method steps for using token labels for image classification, according to various embodiments. Although the method steps are described in conjunction with FIG. 1-8, persons skilled in the art will understand that any system configured to perform the method steps, in any order, falls within the scope of the present disclosure.

The method 900 begins at step 902, where training engine 418 receives training and test data. Training and test data includes images and the corresponding ground truth classifications for the content in the images. For example, the ImageNet-1K dataset can be used for training and testing. ImageNet-1K has 1 million images classified into 1000 categories. In some embodiments, the training and test data is augmented using data augmentation techniques, such as random augmentation, cut out augmentation, spatial augmentation, mix up augmentation, cut mix augmentation, and/or the like.

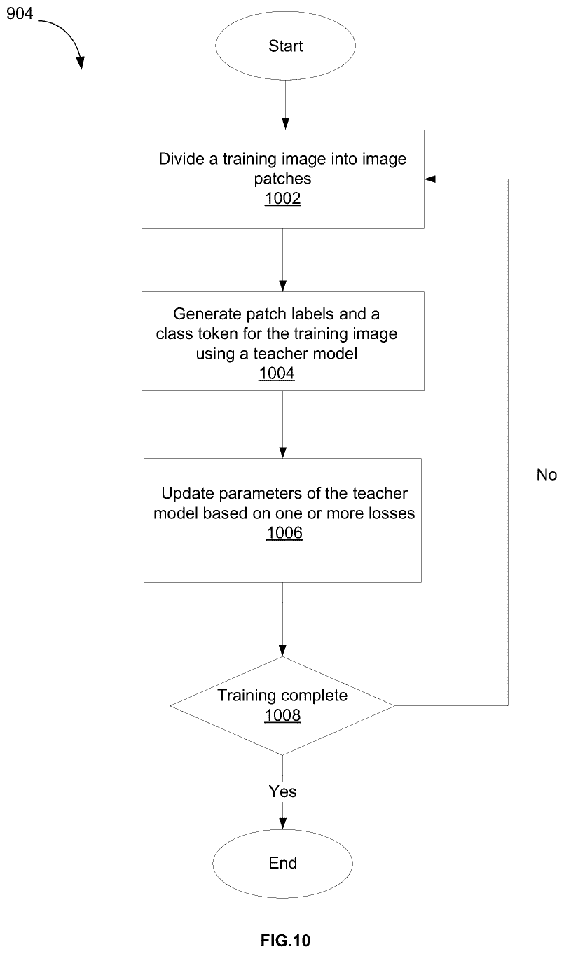

At step 904, training engine 418, trains teacher model 422. Training engine 418 reads training images 522 and ground truth classifications from the training data. Training engine 418 then trains teacher model 422 with training images 522 and the corresponding ground truth classifications to predict patch labels 520 for each of the image patches 504 in the training images. The steps for training teacher model 422 are described in further detail in FIG. 10.

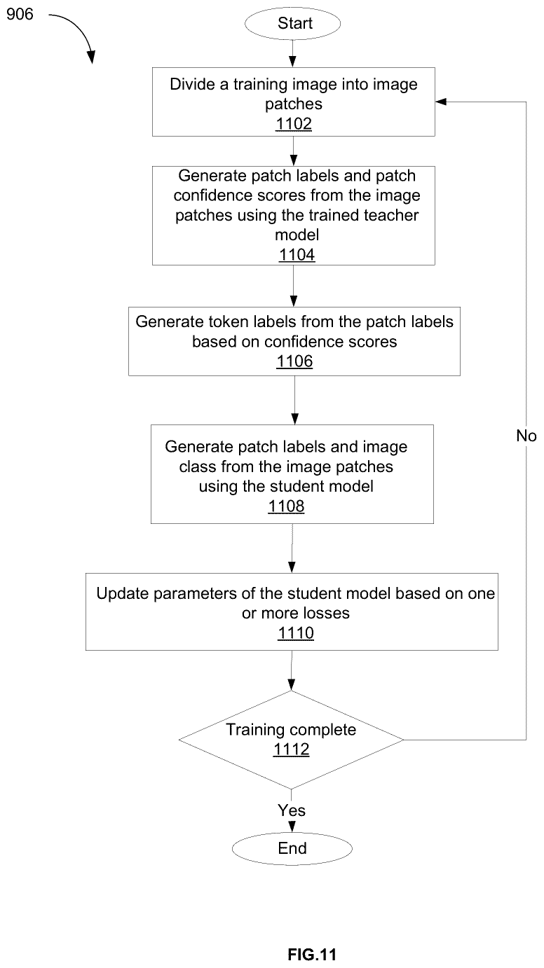

At step 906, training engine 418, uses the trained teacher model 422 to train student model 424. Training engine 418 reads training images 622 and corresponding ground truth classifications. Training engine 418, uses the trained teacher model 422 to predict patch labels 520 for each training image 622 that are used to generate the token labels 616 that assist in the training of student model 424. The steps for training student model 424 are described in further detail in FIG. 11.

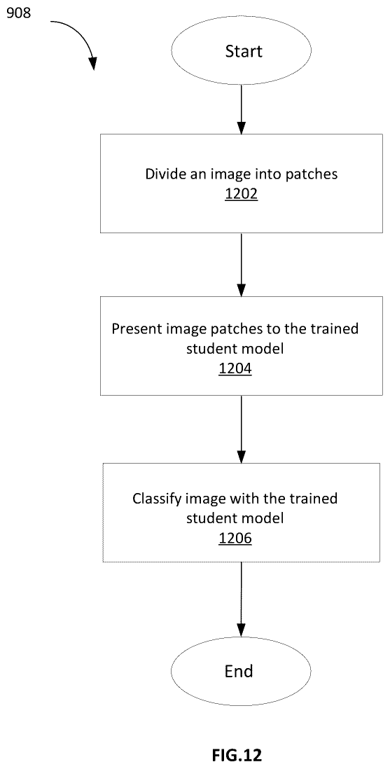

At step 908, execution engine 420 classifies one or more input images 802 using trained student model 424. Input images 802 can be captured by a camera or loaded from storage. The steps for using the trained student model 424 to classify images are described in further detail in FIG. 12.

FIG. 10 is a flow diagram of method steps for training a teacher model to produce token labels, according to various embodiments. Although the method steps are described in conjunction with FIG. 1-8, persons skilled in the art will understand that any system configured to perform the method steps, in any order, falls within the scope of the present disclosure.

As shown in FIG. 10, the step 904 for training teacher model 422 begins at step 1002, where training engine 418 uses image patch generator 502 to divide a training image 522 into image patches 504. For example, image patch generator 502 can divide training image 522 into 16*16 non-overlapping image patches 504. Training image 522 can be selected from the images in the training and test data received during step 902.

At step 1004, training engine 418 generates patch labels 520 and the class token T_{cls} 516 for the training image 522 using teacher model 422. Training engine 418 presents class input CLS 506 and image patches 504 to teacher model 422. Teacher model 422 then predicts respective patch labels 520 corresponding to the classification of the content for the corresponding image patch 504. Teacher model 422 also predicts a classification for the entire training image 522 as class token T_{cls} 516. Training engine 418 randomly generates class input CLS 506 which represents an embedding for the whole image.

At step 1006, training engine 418 updates parameters of teacher model 422 based on one or more losses. Training engine 418 generates the average patch label 524 from patch labels 520 using pooling layer 518. Training engine 418 then generates a first cross entropy loss between the average patch label 524 and the image label Y_{cls}. Training engine 418 also generates a second cross entropy loss between the image label Y_{cls} and class token T_{cls} 516. Training engine 418 then generates a combined loss from the first and second cross entropy losses as shown in Equation 1. Training engine 418 then updates teacher model 422 parameters to minimize the combined losses. For example, training engine 418 uses a backpropagation algorithm to move teacher model 422 parameters in the direction that reduces the combined losses.

At step 1008, training engine 418 determines whether training is complete. Training engine 418 uses a stopping criteria to determine when training is complete. For example, the stopping criteria could be that an aggregate of the combined losses for a set of training or test images has converged for a set number of training iterations. If training engine 418 determines that training is not complete, then training engine 418 returns to step 1002 to load a new training image 522. Training stops if training engine 418 determines that the stopping criteria is met.

FIG. 11 is a flow diagram of method steps for training a student model with token labels, according to various embodiments. Although the method steps are described in conjunction with FIG. 1-8, persons skilled in the art will understand that any system configured to perform the method steps, in any order, falls within the scope of the present disclosure.

As shown in FIG. 11, the step 906 for training student model 424 begins at step 1102, where training engine 418 uses image patch generator 502 to divide a training image 622 into image patches 602. For example, image patch generator 502 can divide training image 622 into 16*16 non-overlapping image patches 602. Training image 622 can selected from the images in the training and test data received during step 902.

At step 1104, training engine 418 generates patch labels 520 for the training image 622 using trained teacher model 422. Training engine 418 presents image patches 602 to trained teacher model 422. Teacher model 422 then predicts respective patch labels 520 corresponding to the classification of the content for the corresponding image patches 602. Teacher model 422 also predicts a confidence score for each respective patch label 520.

At step 1106, training engine 418 generates token labels 616 from patch labels 520 based on the confidence scores for patch labels 520. The Gumbel-Softmax block 614 receives patch labels 520 and the corresponding confidence scores and generates the token labels 616. Patch labels 520 with a high confidence score are not changed by Gumbel-Softmax block 614, but patch labels 520 with a low confidence score are changed to a background classification as shown in FIG. 7.

At step 1108, training engine 418 generates patch labels 620 and the class token T_{cls} 618 for the training image 622 using student model 424. Training engine 418 presents class input CLS 604 and image patches 602 to the student model 424. Student model 424 then predicts respective patch labels 620 corresponding to the classification of the content for the corresponding image patch 602. Student model 424 also predicts a classification for the entire training image 622 as class token T_{cls} 618. Training engine 418 randomly generates class input CLS 604 which represents an embedding for the whole image.

At step 1110, training engine 418 updates parameters of student model 424 based on one or more losses. Training engine 418 presents token labels 616 generated by the Gumbel-Softmax block 614 as corresponding ground truth values for the patch labels 620 generated by student model 424. Training engine 418 then, generates a first cross entropy loss between patch labels 620 and token labels 616. Training engine 418 also generates a second cross entropy loss between the image label Y_{cls} and class token T_{cls} 618. Training engine 418 then generates a combined loss from the first and second cross entropy losses as shown in Equation 3. Training engine 418 updates student model 424 parameters to minimize the combined losses. For example, training engine 418 uses a backpropagation algorithm to move student model 424 parameters in the direction that reduces the combined losses.

At step 1112, training engine 418 determines whether training is complete. Training engine 418 uses a stopping criteria to determine when training is complete. For example, the stopping criteria could be that an aggregate of the combined losses for a set of training or test images has converged for a set number of training iterations. If training engine 418 determines that training is not complete, then training engine 418 returns to step 1102 to load a new training image 622. Training stops if training engine 418 determines that the stopping criteria is met.

FIG. 12 is a flow diagram of method steps for classifying images using the trained student model, according to various embodiments. Although the method steps are described in conjunction with FIG. 1-8, persons skilled in the art will understand that any system configured to perform the method steps, in any order, falls within the scope of the present disclosure. As shown in FIG. 12, the step 908 for classifying one or more images using the trained student model 424 begins at step 1202, where execution engine 420 uses image patch generator 502 to divide an input image 802 into image patches 804. For example, image patch generator 502 can divide input image 802 into 16*16 non-overlapping image patches 804. Input image 802 can be selected from the images in the training and test data received during step 902.

At step 1204, execution engine 420 presents image patches 804 to the trained student model 424. Execution engine 420 can present to the trained student model 424, one or more series of image patches 804 generated from different input images 802.

At step 1206, trained student model 424 generates output class 806. Output class 806 represents output of the trained student model 424 classification for the input image 802. Trained student model 424 can generate one or more output classes if one or more input images are presented by execution engine 420.

In sum, a FAN-based model is trained using a teacher-student approach. The teacher model includes a FAN that is initially trained to generate patch labels for each of the image patches within an image. To assist the teacher model in learning how to predict the patch labels, the teacher model is trained using a loss function that considers not only the ability of the teacher model to classify an image as a whole, but also considers how well the teacher model classifies each of the image patches relative to the known classification for the image as a whole.

The student model includes a FAN that generates patch labels for each of the image patches of an input image. When training the student model, each training image presented to the student model is also presented to the trained teacher model. The trained teacher generates patch labels for the training image, which are processed using a Gumbel-SoftMax to generate token labels based on the confidence scores associated with the patch labels. The Gumbel-SoftMax approach emphasizes the patch labels that have high confidence scores and are more likely to have useful semantic information, while de-emphasizing patch labels with low confidence scores. The generated token labels are provided to the student model as the ground truth classification for the patch labels generated for each image patch by the student model. The loss function for the student model uses this additional ground truth information to train the student model. Once trained, the student model is used to classify images.

One technical advantage of the disclosed techniques relative to the prior art is that, with the disclosed techniques, more accurate token labels are generated for the image patches within training images. The more accurate token labels provide improved training data for image processing tasks, such as image classification. The improved training data results in a trained image processing models that more accurately identifies the content of images. Another technical advantage of the disclosed techniques is that image processing models trained using the disclosed techniques are better at classifying out of distribution data, such as corrupted or noisy images than corresponding image processing models trained using other techniques. A further technical advantage is that smaller image processing models trained using the disclosed techniques can be as effective as some larger image processing models trained using prior approaches, allowing image processing to be performed as effectively using fewer memory and computational resources. These technical advantages provide one or more technological improvements over prior art approaches.

1. In some embodiments, a computer-implemented method for training an image classifier comprises training a first vision transformer model to generate patch labels for corresponding images patches of images, converting the patch labels to token labels, and training a second vision transformer model to classify images based on the token labels.

2. The computer-implemented method of clause 1, wherein the first vision transformer model is a fully attentional network, and the second vision transformer model is a fully attentional network.

3. The computer-implemented method of clauses 1 or 2, wherein training the first vision transformer model comprises dividing a first training image into a plurality of image patches, presenting the plurality of image patches to the first vision transformer model to generate a first image classification for the first training image and a plurality of first respective patch labels representing classifications for the plurality of image patches, computing a first loss based on the first image classification and a ground truth classification for the first training image, computing a second loss based on the ground truth classification for the first training image and the plurality of first respective patch labels, and updating the first vision transformer model based on the first loss and the second loss.

4. The computer-implemented method of any of clauses 1-3, wherein the plurality of image patches are non-overlapping image patches.

5. The computer-implemented method of any of clauses 1-4, wherein computing the second loss comprises computing an average patch label from the plurality of first respective patch labels.

6. The computer-implemented method of any of clauses 1-5, wherein the first loss is a cross entropy loss, and the second loss is a cross entropy loss.

7. The computer-implemented method of any of clauses 1-6, wherein converting the patch labels to the token labels comprises emphasizing the patch labels based on confidence scores for the patch labels.

8. The computer-implemented method of any of clauses 1-7, wherein emphasizing the patch labels based on the confidence scores comprises converting the patch labels with low confidence scores to token labels indicating a background classification.

9. The computer-implemented method of any of clauses 1-8, wherein emphasizing the patch labels comprises processing the patch labels and the confidence scores with a Gumbel-SoftMax block.

10. The computer-implemented method of any of clauses 1-9, wherein training the second vision transformer model comprises dividing a first training image into a plurality of image patches, presenting the plurality of image patches to the first vision transformer model to generate a plurality of first patch labels representing respective classifications for each of the plurality of image patches by the first vision transformer model, converting the plurality of first patch labels to a plurality of token labels for the plurality of image patches, presenting the plurality of image patches to the second vision transformer model to generate an image classification for the first training image and a plurality of second patch labels representing respective classifications for the plurality of image patches by the second vision transformer model, computing a first loss based on based on the image classification and a ground truth classification for the first training image, computing a second loss based on the plurality of token labels and the plurality of second patch labels, and updating the second vision transformer model based on the first loss and the second loss.

11. The computer-implemented method of any of clauses 1-10, further comprising computing a combined loss from the first loss and the second loss.

12. The computer-implemented method of any of clauses 1-11, wherein the first loss is a cross entropy loss, and the second loss is an aggregate of respective cross entropy losses between the plurality of token labels and the plurality of second patch labels.

13. In some embodiments, one or more non-transitory computer readable media store instructions that, when executed by one or more processors, cause the one or more processors to perform the steps of training a first vision transformer model to generate patch labels for corresponding images patches of images, converting the patch labels to token labels, and training a second vision transformer model to perform an image processing task based on the token labels.

14. The one or more non-transitory computer-readable media of clause 13, wherein the image processing task is image classification.

15. The one or more non-transitory computer readable media of clauses 13 or 14, wherein the first vision transformer model is a fully attentional network, and the second vision transformer model is a fully attentional network.

16. The one or more non-transitory computer readable media of any of clauses 13-15, wherein training the first vision transformer model comprises dividing a first training image into a plurality of image patches, presenting the plurality of image patches to the first vision transformer model to generate a first image classification for the first training image and a plurality of first respective patch labels representing classifications for the plurality of image patches, computing a first loss based on the first image classification and a ground truth classification for the first training image, computing a second loss based on the ground truth classification for the first training image and the plurality of first respective patch labels, and updating the first vision transformer model based on the first loss and the second loss.

17. The one or more non-transitory computer readable media of any of clauses 13-16, wherein converting the patch labels to the token labels comprises emphasizing the patch labels based on confidence scores for the patch labels.

18. The one or more non-transitory computer readable media of any of clauses 13-17, wherein emphasizing the patch labels comprises processing the patch labels and the confidence scores with a Gumbel-SoftMax block.

19. The one or more non-transitory computer readable media of any of clauses 13-18, wherein training the second vision transformer model comprises dividing a first training image into a plurality of image patches, presenting the plurality of image patches to the first vision transformer model to generate a plurality of first patch labels representing respective classifications for each of the plurality of image patches by the first vision transformer model, converting the plurality of first patch labels to a plurality of token labels for the plurality of image patches, presenting the plurality of image patches to the second vision transformer model to perform the image processing task for the first training image and a plurality of second patch labels representing respective classifications for the plurality of image patches by the second vision transformer model, computing a first loss based on based on results of the image processing task and a ground truth result for the first training image, computing a second loss based on the plurality of token labels and the plurality of second patch labels, and updating the second vision transformer model based on the first loss and the second loss.

20. In some embodiments, a system comprises one or more memories storing instructions, and one or more processors that are coupled to the one or more memories and, when executing the instructions, are configured to receive an image, divide the image into a plurality of image patches, and present the plurality of image patches to a first vision transformer model to perform an image processing task on the image, wherein the first vision transformer model is trained based on a plurality of token labels for image patches of training images, the plurality of token labels being determined from a plurality of patch labels generated by a second vision transformer model trained to generate patch labels for training images.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training an image classifier, the method comprising:
training a first vision transformer model to generate patch labels for corresponding images patches of images;
converting the patch labels to token labels; and
training a second vision transformer model to classify images based on the token labels.

2. The computer-implemented method of claim 1, wherein:
the first vision transformer model is a fully attentional network; and
the second vision transformer model is a fully attentional network.

3. The computer-implemented method of claim 1, wherein training the first vision transformer model comprises:
dividing a first training image into a plurality of image patches;
presenting the plurality of image patches to the first vision transformer model to generate a first image classification for the first training image and a plurality of first respective patch labels representing classifications for the plurality of image patches;
computing a first loss based on the first image classification and a ground truth classification for the first training image;
computing a second loss based on the ground truth classification for the first training image and the plurality of first respective patch labels; and
updating the first vision transformer model based on the first loss and the second loss.

4. The computer-implemented method of claim 3, wherein the plurality of image patches are non-overlapping image patches.

5. The computer-implemented method of claim 3, wherein computing the second loss comprises computing an average patch label from the plurality of first respective patch labels.

6. The computer-implemented method of claim 3, wherein:
the first loss is a cross entropy loss; and
the second loss is a cross entropy loss.

7. The computer-implemented method of claim 3, wherein converting the patch labels to the token labels comprises emphasizing the patch labels based on confidence scores for the patch labels.

8. The computer-implemented method of claim 7, wherein emphasizing the patch labels based on the confidence scores comprises converting the patch labels with low confidence scores to token labels indicating a background classification.

9. The computer-implemented method of claim 7, wherein emphasizing the patch labels comprises processing the patch labels and the confidence scores with a Gumbel-SoftMax block.

10. The computer-implemented method of claim 1, wherein training the second vision transformer model comprises:
dividing a first training image into a plurality of image patches;
presenting the plurality of image patches to the first vision transformer model to generate a plurality of first patch labels representing respective classifications for each of the plurality of image patches by the first vision transformer model;
converting the plurality of first patch labels to a plurality of token labels for the plurality of image patches;
presenting the plurality of image patches to the second vision transformer model to generate an image classification for the first training image and a plurality of second patch labels representing respective classifications for the plurality of image patches by the second vision transformer model;
computing a first loss based on based on the image classification and a ground truth classification for the first training image;
computing a second loss based on the plurality of token labels and the plurality of second patch labels; and
updating the second vision transformer model based on the first loss and the second loss.

11. The computer-implemented method of claim 10, further comprising computing a combined loss from the first loss and the second loss.

12. The computer-implemented method of claim 10, wherein:
the first loss is a cross entropy loss; and
the second loss is an aggregate of respective cross entropy losses between the plurality of token labels and the plurality of second patch labels.

13. One or more non-transitory computer readable media storing instructions that, when executed by one or more processors, cause the one or more processors to perform the steps of:
training a first vision transformer model to generate patch labels for corresponding images patches of images;
converting the patch labels to token labels; and
training a second vision transformer model to perform an image processing task based on the token labels.

14. The one or more non-transitory computer-readable media of claim 13, wherein the image processing task is image classification.

15. The one or more non-transitory computer readable media of claim 13, wherein:
the first vision transformer model is a fully attentional network; and
the second vision transformer model is a fully attentional network.

16. The one or more non-transitory computer readable media of claim 13, wherein training the first vision transformer model comprises:
dividing a first training image into a plurality of image patches;
presenting the plurality of image patches to the first vision transformer model to generate a first image classification for the first training image and a plurality of first respective patch labels representing classifications for the plurality of image patches;
computing a first loss based on the first image classification and a ground truth classification for the first training image;
computing a second loss based on the ground truth classification for the first training image and the plurality of first respective patch labels; and
updating the first vision transformer model based on the first loss and the second loss.

17. The one or more non-transitory computer readable media of claim 16, wherein converting the patch labels to the token labels comprises emphasizing the patch labels based on confidence scores for the patch labels.

18. The one or more non-transitory computer readable media of claim 17, wherein emphasizing the patch labels comprises processing the patch labels and the confidence scores with a Gumbel-SoftMax block.

19. The one or more non-transitory computer readable media of claim 13, wherein training the second vision transformer model comprises:
dividing a first training image into a plurality of image patches;
presenting the plurality of image patches to the first vision transformer model to generate a plurality of first patch labels representing respective classifications for each of the plurality of image patches by the first vision transformer model;
converting the plurality of first patch labels to a plurality of token labels for the plurality of image patches;
presenting the plurality of image patches to the second vision transformer model to perform the image processing task for the first training image and a plurality of second patch labels representing respective classifications for the plurality of image patches by the second vision transformer model;
computing a first loss based on based on results of the image processing task and a ground truth result for the first training image;
computing a second loss based on the plurality of token labels and the plurality of second patch labels; and
updating the second vision transformer model based on the first loss and the second loss.

20. A system comprising:
one or more memories storing instructions, and
one or more processors that are coupled to the one or more memories and, when executing the instructions, are configured to:
receive an image;
divide the image into a plurality of image patches; and
present the plurality of image patches to a first vision transformer model to perform an image processing task on the image, wherein the first vision transformer model is trained based on a plurality of token labels for image patches of training images, the plurality of token labels being determined from a plurality of patch labels generated by a second vision transformer model trained to generate patch labels for training images.
